(19) United States
(12) Patent Application Publication
(10) Pub. No.: US 2026/0170695 A1
(43) Pub. Date: Jun. 18, 2026

(54) Decoding JPEG-Like Video Codecs Using a Hardware JPEG Decoder

(71) Applicant: Advanced Micro Devices, Inc., Santa Clara, CA (US)

(72) Inventor: Mark Ross Thompson, Cambridge (GB)

(73) Assignee: Advanced Micro Devices, Inc., Santa Clara, CA (US)

(21) Appl. No.: 18/985,991

(22) Filed: Dec. 18, 2024

(51) Int. Cl. G06T 9/00; H04N 19/42

(52) U.S. Cl. CPC G06T 9/00; H04N 19/42

(57) ABSTRACT

Decoding JPEG-like video codecs using a hardware JPEG decoder is described. In one or more implementations, a system for decoding data encoded with a JPEG-like codec includes a processor, a multimedia unit configured to decode encoded JPEG images, and a memory storing instructions. When executed by the processor, the instructions cause the processor to receive input data encoded with a JPEG-like codec from the memory, preprocess the input data to produce preprocessed data compatible with JPEG decoding, and provide the preprocessed data to the multimedia unit to decode the preprocessed data using at least a portion of a JPEG decoding process.

### BACKGROUND

Image and video compression techniques are widely used to reduce file sizes for storage and transmission. Joint Photographic Experts Group, commonly known as JPEG, is one of the most common image compression formats, utilizing discrete cosine transforms and quantization to achieve lossy compression. While JPEG is ubiquitous, several other intra-frame codecs have been developed that build upon or modify aspects of JPEG compression. These JPEG-like codecs aim to provide improved quality, efficiency, or features for specific use cases, particularly in professional video production workflows.

### BRIEF DESCRIPTION OF THE DRAWINGS

FIG. 1 is a block diagram of a processing system configured to execute one or more applications, in accordance with one or more implementations.

FIG. 2 depicts a non-limiting example system having a processor configured to convert video data from a JPEG-like format to a JPEG format and a multimedia unit configured to reconstruct video from the video data in the JPEG format.

FIG. 3 depicts a non-limiting example configuration of a multimedia unit.

FIG. 4 depicts another non-limiting example system having a processor configured to convert video data from a JPEG-like format to a JPEG format, decode the video data in the JPEG format, and output quantized coefficients to a multimedia unit configured to reconstruct video from the quantized coefficients.

FIG. 5 depicts another non-limiting example configuration of a multimedia unit.

FIG. 6 depicts a method for decoding JPEG-like codecs.

FIG. 7 depicts another method for decoding JPEG-like codecs.

### DETAILED DESCRIPTION

### Overview

Image and video compression techniques are widely used to reduce file sizes for storage and transmission. JPEG is one of the most common image compression formats, utilizing discrete cosine transforms and quantization to achieve lossy compression. While JPEG is ubiquitous, several other intra-frame codecs have been developed that build upon or modify aspects of JPEG compression. These JPEG-like codecs aim to provide improved quality, efficiency, or features for specific use cases, particularly in professional video production workflows. Conventional systems implemented in hardware typically require dedicated hardware for each codec variant, which can be costly and impractical to implement.

In contrast, the described techniques leverage commonalities between JPEG and JPEG-like codecs to enable decoding of multiple formats using a single hardware decoder (e.g., a hardware JPEG decoder) and preprocessing in software. For example, these techniques provide an adaptive approach for decoding data (e.g., video data), encoded with JPEG-like codecs, using existing JPEG decoding hardware. As used herein, the term “JPEG-like codecs” refers to image or video compression formats that share similarities with or are derived from the JPEG (Joint Photographic Experts Group) standard. These codecs may utilize similar principles such as discrete cosine transforms, quantization, and entropy coding, but may incorporate modifications or enhancements to address specific requirements or use cases. By way of example and not limitation, JPEG-like codecs may include, formats involving intra-frame compression schemes, such as video codecs like DNxHD and ProRes.

At a high level, the described approach involves performing a preprocessing step on input data (e.g., input video data) encoded with a JPEG-like codec to generate preprocessed data that is compatible with JPEG decoding. This preprocessed data is then decoded using at least a portion of a standard JPEG decoding process implemented in hardware, e.g., a multimedia unit configured as a JPEG encoder and/or decoder. By intelligently preprocessing the input data and selectively bypassing certain decoding steps, the system can efficiently decode multiple JPEG-like formats without requiring separate dedicated hardware for each such format.

Instead, the preprocessing step performed by the processor in software can be tailored to the specific JPEG-like codec format of the input data. For example, the preprocessing step may involve entropy decoding, coefficient reordering, and/or other transformations to convert the input into a JPEG-compatible format. In one or more implementations, this preprocessing is performed by a general-purpose processor (e.g., a host central processing unit (CPU)). Alternatively or additionally, the preprocessing is performed by a specialized processor (e.g., a digital signal processor (DSP)) integrated with the JPEG decoding hardware.

An advantage of the described approach is that it allows reuse of existing JPEG decoding hardware to support additional codec formats. The dequantization and inverse discrete cosine transform (IDCT) stages of JPEG decoding are often implemented efficiently in hardware. By preprocessing the input data, these hardware stages can be leveraged to decode JPEG-like formats as well.

In one or more implementations, the preprocessing step generates fully JPEG-compatible data that can be processed by an unmodified JPEG decoder. In at least one variation, the preprocessing produces partially compatible data, allowing certain stages of JPEG decoding (e.g. entropy decoding) to be bypassed while still utilizing later stages like dequantization and/or inverse discrete cosine transform (IDCT).

The disclosed techniques are applicable to professional video codecs like DNxHD, VC-3, and ProRes, which share many similarities with JPEG. However, the approach is extendable to other JPEG-like formats as well.

By enabling flexible decoding of multiple formats using a single hardware decoder, the described techniques provide significant advantages in terms of cost, power efficiency, and implementation complexity compared to conventional approaches requiring dedicated hardware for each codec variant. The described techniques also offer advantages over purely software decoding approaches. By leveraging existing JPEG hardware acceleration, for instance, the described system achieves significantly faster decoding speeds and lower power consumption compared to software-only implementations.

In some aspects, the techniques described herein relate to a system for decoding data encoded with a JPEG-like codec, including: a processor, a multimedia unit configured to decode encoded JPEG images, and a memory storing instructions that, when executed by the processor, cause the processor to: receive input data encoded with a JPEG-like codec from the memory, preprocess the input data to produce preprocessed data compatible with JPEG decoding, and provide the preprocessed data to the multimedia unit to decode the preprocessed data using at least a portion of a JPEG decoding process.

In some aspects, the techniques described herein relate to a system, wherein the processor is a central processing unit (CPU).

In some aspects, the techniques described herein relate to a system, wherein the processor is an accelerated unit (AU).

In some aspects, the techniques described herein relate to a system, wherein the preprocessing includes converting the input data into a format compatible with JPEG decoding, and storing the converted data in the memory.

In some aspects, the techniques described herein relate to a system, wherein the multimedia unit is configured to bypass an entropy decoding step of the JPEG decoding process to decode the preprocessed data.

In some aspects, the techniques described herein relate to a system, wherein the processor is further configured to perform entropy decoding specific to the JPEG-like codec.

In some aspects, the techniques described herein relate to a system, further including a dedicated processor configured to perform the preprocessing.

In some aspects, the techniques described herein relate to a system, wherein the dedicated processor is integrated with the multimedia unit and is programmable to support preprocessing for at least two JPEG-like codecs.

In some aspects, the techniques described herein relate to a system, wherein the dedicated processor is a digital signal processor.

In some aspects, the techniques described herein relate to an apparatus for decoding data encoded with a JPEG-like codec, including: a processor, and a memory storing instructions that, when executed by the processor, cause the apparatus to: receive input data encoded with a JPEG-like codec, preprocess the input data to produce preprocessed data compatible with JPEG decoding, and provide the preprocessed data to a multimedia unit configured to decode encoded JPEG images using a JPEG decoding process.

In some aspects, the techniques described herein relate to an apparatus, wherein the processor is a central processing unit (CPU).

In some aspects, the techniques described herein relate to an apparatus, wherein the processor is an accelerated unit (AU).

In some aspects, the techniques described herein relate to an apparatus, wherein the processor is a digital signal processor (DSP) integrated with the multimedia unit.

In some aspects, the techniques described herein relate to an apparatus, wherein the preprocessing includes converting the input data into a format compatible with JPEG decoding, and storing the converted data in the memory.

In some aspects, the techniques described herein relate to an apparatus, wherein the processor is further configured to perform entropy decoding specific to the JPEG-like codec to cause the multimedia unit to bypass an entropy decoding step of the JPEG decoding process.

In some aspects, the techniques described herein relate to a method for decoding JPEG-like codecs using JPEG decoding hardware, including: receiving, by a processor, input data encoded in a JPEG-like codec format, preprocessing, by the processor, the input data to produce preprocessed data compatible with JPEG decoding, and decoding, by a multimedia unit configured for JPEG decoding, the preprocessed data using at least a portion of a JPEG decoding process.

In some aspects, the techniques described herein relate to a method, wherein the preprocessing includes decoding entropy-coded data specific to the JPEG-like codec, and reordering coefficient data to be compatible with JPEG decoding.

In some aspects, the techniques described herein relate to a method, wherein decoding the preprocessed data includes bypassing at the multimedia unit an entropy decoding step of the JPEG decoding process.

In some aspects, the techniques described herein relate to a method, wherein the preprocessed data is input to a dequantization step of the JPEG decoding process.

In some aspects, the techniques described herein relate to a method, further including multiplying the preprocessed data by a per-slice quantizer value specific to the JPEG-like codec prior to inputting the preprocessed data to the dequantization step.

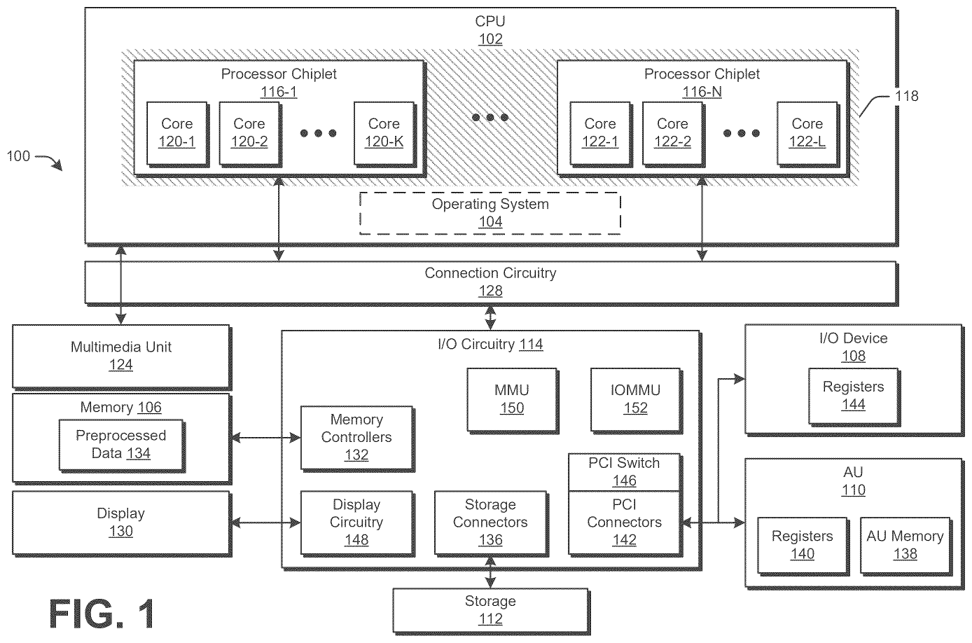

FIG. 1 is a block diagram of a processing system configured to execute one or more applications, in accordance with one or more implementations.

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 112, I/O circuitry 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations.

Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

In this example, multimedia unit 124 is depicted communicably coupled to the CPU 102. In variations, the multimedia unit 124 is communicably coupled to the AU 110. Alternatively or additionally, the multimedia unit 124 is included in and/or is implemented by one or more various components of the processing system 100, such as the CPU 102, the AU 110, and so forth. In accordance with the described techniques, the multimedia unit 124 is a hardware component that includes circuitry configured to perform various stages of decoding and/or encoding JPEG formatted data (e.g., video data). The multimedia unit 124 is further configured to at least one of output decoded data (e.g., decoded from a JPEG or partial JPEG format) or encoded data (e.g., JPEG encoded data). The multimedia unit 124 may also be communicably coupled to the memory 106, such as to write data to and receive preprocessed data from the memory 106 in connection with the described techniques for decoding input data (e.g., video data) encoded with a JPEG-like codec.

Additionally, within the processing system 100, the CPU 102 is communicatively coupled to an I/O circuitry 114 by a connection circuitry 128. For example, each processor chiplet 116 of the CPU 102 is communicatively coupled to the I/O circuitry 114 by the connection circuitry 128. The connection circuitry 128 includes, for example, one or more data fabrics, buses, buffers, queues, and the like. The I/O circuitry 114 is configured to facilitate communications between two or more components of the processing system 100 such as between the CPU 102, system memory 106, display 130, universal serial bus (USB) devices, peripheral component interconnect (PCI) devices (e.g., I/O device 108, AU 110), storage 112, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 114 includes one or more memory controllers 132. These memory controllers 132, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 132 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of preprocessed data 134 (e.g., input video data converted into a format compatible with JPEG decoding) associated with an application from, for example, storage 112 into system memory 106. This storage 112, for example, includes a non-volatile storage such as a flash memory, solid-state memory, hard disk, optical disc, or the like configured to store preprocessed data 134 for one or more applications.

To facilitate communication between the storage 112 and other components of processing system 100, the I/O circuitry 114 includes one or more storage connectors 136 (e.g., universal serial bus (USB) connectors, serial AT attachment (SATA) connectors, PCI Express (PCIe) connectors) configured to communicatively couple storage 112 to the I/O circuitry 114 such that I/O circuitry 114 is capable of routing signals to and from the storage 112 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 138. This AU memory 138, for example, includes any combination of one or more volatile memories and/or non-volatile memories, examples of which include caches, video RAM (VRAM), or the like. In one or more implementations, these compute units are also configured to execute these threads based on the data stored in one or more physical registers 140 of the AU 110.

To facilitate communication between the AU 110 and one or more other components of processing system 100, the I/O circuitry 114 includes or is otherwise connected to one or more connectors, such as PCI connectors 142 (e.g., PCIe connectors) each including circuitry configured to communicatively couple the AU 110 to the I/O circuitry such that the I/O circuitry 114 is capable of routing signals to and from the AU 110 to one or more other components of the processing system 100. Further, the PCIe connectors 142 are configured to communicatively couple the I/O device 108 to the I/O circuitry 114 such that the I/O circuitry 114 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 144 of the I/O device 108. In one or more implementations, such physical registers 144 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 142, and one or more other components of the processing system 100, the I/O circuitry 114 includes PCI switch 146. The PCI switch 146, for example, includes circuitry configured to route packets to and from the components of the processing system 100 connected to the PCI connectors 142 as well as to the other components of the processing system 100. As an example, based on address data indicated in a packet received from a first component (e.g., CPU 102), the PCI switch 146 routes the packet to a corresponding component (e.g., AU 110) connected to the PCI connectors 142.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 112, displays the scene on the display 130, or both. The display 130, for example, includes a cathode-ray tube (CRT) display, liquid crystal display (LCD), light emitting diode (LED) display, organic light emitting diode (OLED) display, or any combination thereof. To enable the processing system 100 to display a scene on the display 130, the I/O circuitry 114 includes display circuitry 148. The display circuitry 148, for example, includes high-definition multimedia interface (HDMI) connectors, DisplayPort connectors, digital visual interface (DVI) connectors, USB connectors, and the like, each including circuitry configured to communicatively couple the display 130 to the I/O circuitry 114. Additionally or alternatively, the display circuitry 148 includes circuitry configured to manage the display of one or more scenes on the display 130 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 114 includes memory management unit (MMU) 150 and input-output memory management unit (IOMMU) 152. The MMU 150 includes, for example, circuitry configured to manage memory requests, such as from the CPU 102 to the system memory 106. For example, the MMU 150 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 150 is configured to translate the virtual address indicated in the memory request to a physical address in the system memory 106 and to fulfill the request. The IOMMU 152 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 144 of the I/O device 108, the registers 140 of the AU 110, and/or the AU memory 138, the CPU 102 issues one or more MMIO requests. Such MMIO requests each request access to read, write, fetch, or pre-fetch data residing at one or more virtual addresses (e.g., guest virtual addresses) which each represent at least a portion of the registers 144 of the I/O device 108, the registers 140 of the AU 110, or the AU memory 138, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 152 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The 100 is configurable in a variety of ways with different combinations of components in accordance with the described techniques.

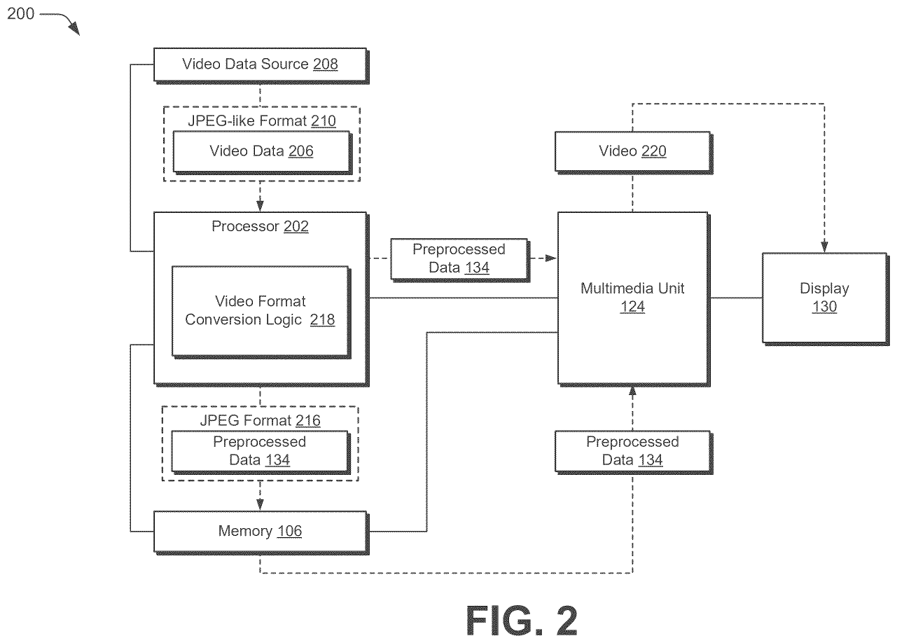

FIG. 2 depicts a non-limiting example system 200 having a processor configured to convert video data from a JPEG-like format to a JPEG format and a multimedia unit configured to reconstruct video from the video data in the JPEG format. Examples of devices in which the system 200 is implemented include, but are not limited to, supercomputers and/or computer clusters of high-performance computing (HPC) environments, servers, personal computers, laptops, televisions, monitors, other display devices, desktops, game consoles, set top boxes, tablets, smartphones, mobile devices, virtual and/or augmented reality devices, wearables, medical devices, system-on-a-chip (SoC), and other computing devices or systems.

The illustrated system 200 includes a processor 202 and the multimedia unit 124. In the context of FIG. 1, examples of the processor include the CPU 102 and the AU 110. It is to be appreciated that the CPU 102 and the AU 110 are merely examples of the processor 202, and the processor 202 may be implemented using any of a variety of processors or processor like hardware components configured to execute instructions from programs, such as to execute instructions from programs to preprocess video data encoded with a JPEG-like codec. The processor 202 and the multimedia unit 124 are electronic circuits that perform various operations on and/or using video data 206 received or otherwise obtained from one or more video data sources 208, such as a storage device (e.g., internal or external to the system 200), a server communicatively coupled (e.g., via one or more networks) to the system 200, media (e.g., an optical disk), or the like. In accordance with the described techniques, rather than being formatted in exactly the JPEG format, the video data 206 from the video data source 208 is instead formatted in a JPEG-like format 210, examples of which are discussed above.

In the illustrated example, the processor 202 and the multimedia unit 124 are illustrated as separate components of the system 200. In at least one variation, however, the processor 202 and the multimedia unit 124 are combined, such as integrated together on a system-on-a-chip (SoC). The processor 202, in one or more implementations, is a central processing unit (CPU) or a portion thereof (e.g., one core of multiple cores that are integrated into the CPU). Other implementations of the processor 202 include, but are not limited to, a field programmable gate array (FPGA), an accelerator unit (AU), and a digital signal processor (DSP).

The processor 202 and the multimedia unit 124 are communicatively coupled to memory 106, examples of connections that facilitate communication between hardware components are discussed above in FIG. 1. In the illustrated example, the memory 106 is depicted receiving preprocessed data 134 in a JPEG format 216 for storing. It is to be appreciated that the memory 106 is also configured to store a variety of other data to support the described techniques, such as the video data 206 in the JPEG-like format 210, in one or more scenarios.

In this example, the processor 202 is depicted including video format conversion logic 218. The video format conversion logic 218 is configured to perform a video format conversion by preprocessing the video data 206 in the JPEG-like format 210 to produce the preprocessed data 134, which is formatted in the JPEG format 216. In one or more implementations, the video format conversion logic 218 is implemented as video format conversion software, and the processor 202 is configured to execute instructions of the video format conversion software to perform the preprocessing step for the video format conversion. For example, the processor 202 executes the video format conversion software to convert the video data 206 in the JPEG-like format 210 into the preprocessed data 134 in the JPEG format 216. In other implementations, the video format conversion logic 218 is implemented as hardware that is configured to perform the video format conversion. By way of example, the processor 202 includes special-purpose hardware (e.g., an FPGA or ASIC) that performs the video format conversion. Hybrid solutions for the video format conversion logic 218 are also contemplated, such as using hardware acceleration techniques to improve efficiency and quality of the conversion.

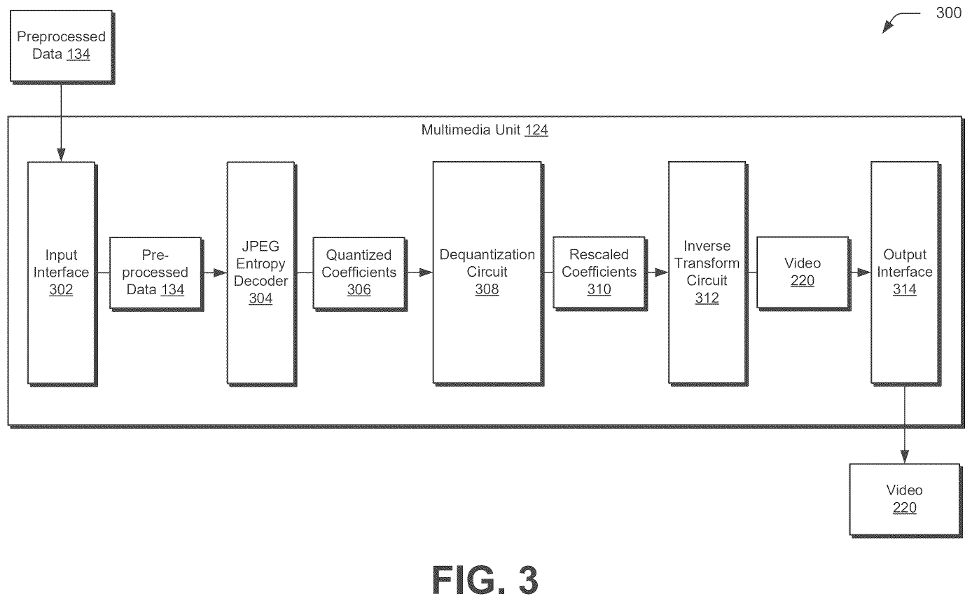

The multimedia unit 124 is configured to receive or otherwise obtain the preprocessed data 134 directly from the processor 202 and/or to read the preprocessed data 134 from the memory 106 for further processing. The multimedia unit 124 is further configured to reconstruct the preprocessed data 134 in the JPEG format 216 into video 220 ready for output, such as for output via the display 130. Additional details of how the multimedia unit 124 performs the reconstruction process are discussed further below in relation to FIG. 3.

In the illustrated example, the multimedia unit 124 is communicatively coupled to the display 130, such as via a wired and/or wireless connection. By way of example, the display 130 may be integrated into a device such as a laptop, television, monitor, other display device, tablet, smartphone, mobile device, virtual and/or augmented reality device, wearable, and so on. Alternatively, the display 130 is part of a device external to the system 200. For example, the display is a stand-alone television, monitor, or other display device. The multimedia unit 124 and the display 130 communicate via one or more video standards, some examples of which include, but are not limited to, video graphics array (VGA), digital visual interface (DVI), high-definition multimedia interface (HDMI), DisplayPort, USB-C, variations thereof (e.g., mini or micro connector version), and the like.

FIG. 3 depicts a non-limiting example configuration 300 of the multimedia unit 124 introduced in FIG. 2 and components thereof. The multimedia unit 124 includes various interfaces, circuitry, and software modules (i.e., one or more portions of code) used to reconstruct the preprocessed data 134 into the video 220 for output, such as for output to the display 130.

In the illustrated example, the multimedia unit 124 includes an input interface 302 configured to receive, as input, the preprocessed data 134 directly from the processor 202 or from the memory 106 and pass the preprocessed data 134 to a JPEG entropy decoder 304. In one or more implementations, the input interface 302 is or includes peripheral connection interface (PCI), PCI Express (PCIe), Thunderbolt, and/or integrated solutions through an interprocessor communication architecture or interconnect architecture. As such, the input interface 302 supports connectivity between the processor 202 and the multimedia unit 124 in configurations where the processor 202 and the multimedia unit 124 are on the same or different dies, on the same or different sockets, and various other configurations.

The input interface 302 provides the preprocessed data 134 to a JPEG entropy decoder 304. The JPEG entropy decoder 304 is a component in the JPEG decompression process that reverses entropy encoding, such as Huffman coding, used in JPEG compression. In one or more implementations, the JPEG entropy decoder 304 is implemented as special-purpose hardware configured to perform hardware-based decoding. Alternatively, the JPEG entropy decoder 304 is implemented in software executed by the multimedia unit 124. Hybrid decoding in which the functionality of the JPEG entropy decoder 304 is implemented in hardware and software is also contemplated.

The JPEG entropy decoder 304 starts by interpreting the compressed bitstream in the preprocessed data 134 according to the Huffman tables defined in a header corresponding to the file containing the preprocessed data 134. These tables map variable-length bit sequences to specific values, allowing the JPEG entropy decoder 304 to efficiently translate the compacted bitstream back into a sequence of quantized coefficients 306 (e.g., Discrete Cosine Transform (DCT) coefficients). The decoding process involves reading the bitstream, matching sequences of bits to the corresponding symbols in the Huffman table, and outputting the associated values. This process reconstructs the sequence of quantized coefficients 306. Additionally, in one or more implementations, the JPEG entropy decoder 304 uses run-length encoding (RLE) in conjunction with Huffman coding in JPEG files, which means the JPEG entropy decoder 304 also processes RLE tuples that represent sequences of zeros (common in DCT coefficients). After entropy decoding, the JPEG entropy decoder 304 has the sequence of quantized coefficients 306, which the JPEG entropy decoder 304 passes to the next stages of JPEG decompression - dequantization and inverse transform to reconstruct the video 220.

The multimedia unit 124 also includes a dequantization circuit 308. The dequantization circuit 308 performs a dequantization process in JPEG decoding to reverse the quantization process applied during JPEG encoding. The dequantization process starts with the quantized coefficients 306, which are the result of the entropy decoding stage performed by the JPEG entropy decoder 304 and described above. The sequence of quantized coefficients 306 have been compressed by the quantization process in the encoder, where each coefficient was divided by a corresponding value in a quantization matrix and rounded. This step significantly reduces the file size but introduces lossiness. The dequantization circuit 308 then accesses a quantization matrix (or matrices) generated during the conversion process. This matrix contains values used to scale down the sequence of quantized coefficients 306 during compression. The preprocessed data 134, in some implementations, includes the quantization matrix.

The dequantization circuit 308 then multiplies each coefficient in the sequence of quantized coefficients 306 by its corresponding value in the quantization matrix. This operation is the inverse of the quantization step performed during encoding (i.e., division). The result is a sequence of rescaled coefficients 310, which are approximations of the original DCT coefficients before quantization. By multiplying with the quantization matrix, the frequency data represented by the quantized coefficients 306 is approximately restored. However, due to the lossy nature of the quantization process, this restoration is not perfect, and some data loss or quality degradation is possible.

Once dequantization is complete, the sequence of rescaled coefficients 310 are provided to an inverse transform circuit 312 (e.g., an inverse DCT). The inverse transform circuit 312 transforms the sequence of rescaled coefficients 310 back into pixel values, completing reconstruction of the preprocessed data 134 into the video 220. The inverse transform circuit 312 provides the video 220 to an output interface 314 that is configured to output the video 220, for example, to the display 130.

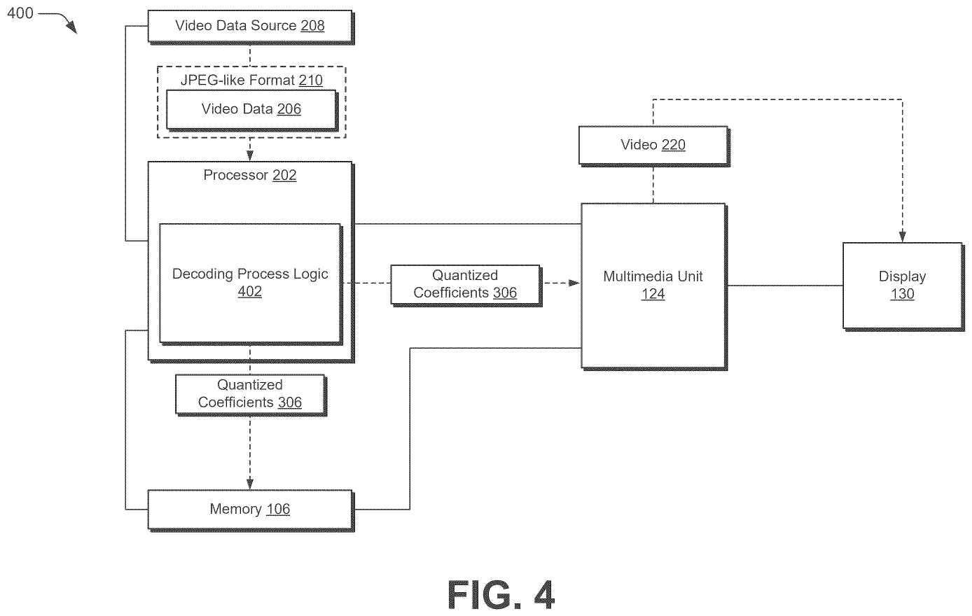

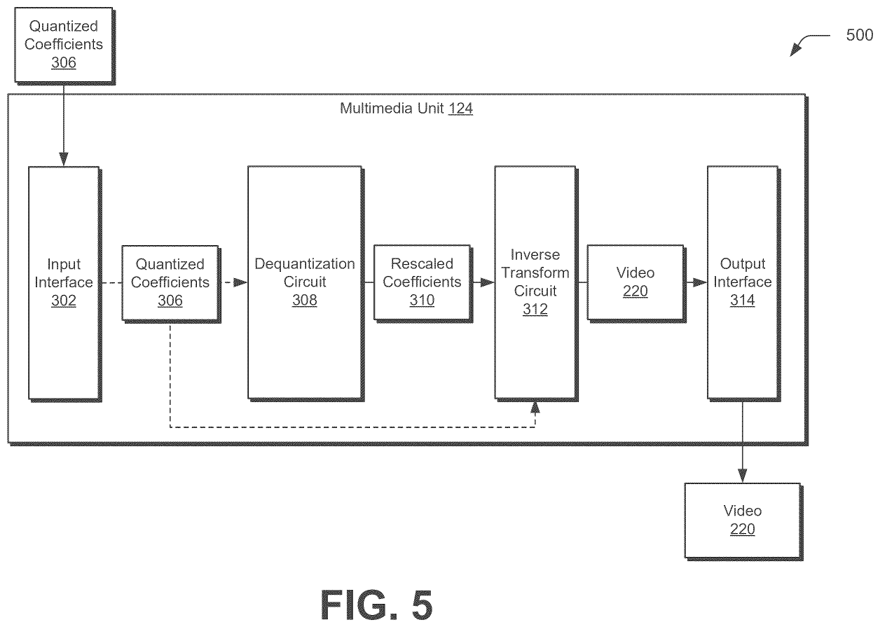

FIG. 4 depicts another non-limiting example system 400. The system 400 includes the processor 202, the multimedia unit 124, the video data 206 in the JPEG-like format 210, the video source 208, the memory 106, the quantized coefficients 306, the video 220, and the display 130 illustrated and described above with reference to FIG. 2. In the system 400, the processor 202 receives or otherwise obtains the video data 206 in the JPEG-like format 210 from the video data source 208 and performs a decoding process according to decoding process logic 402 that generates the sequence of quantized coefficients 306. In some implementations, the processor 202 provides the sequence of quantized coefficients 306 directly to the multimedia unit 124. In alternative implementations, the processor 202 provides the sequence of quantized coefficients 306 to the memory 106 for temporary storage until the multimedia unit 124 is ready to process the sequence of quantized coefficients 306. In either case, the sequence of quantized coefficients 306 are processed by the latter parts of the multimedia unit 124 as depicted in FIG. 5 and described below.

FIG. 5 depicts another non-limiting example configuration 500 of the multimedia unit 124 introduced in FIG. 2. The multimedia unit 124 in the configuration 500 includes various interfaces, circuitry, and software modules used to receive or otherwise obtain the sequence of quantized coefficients 306 directly from the processor 202 and to perform operations to reconstruct the video 220 from the sequence of quantized coefficients 306.

In the illustrated example, the multimedia unit 124 includes the input interface 302 configured to receive, as input, the sequence of quantized coefficients 306 and to pass the sequence of quantized coefficients 306 to the dequantization circuit 308. The dequantization circuit 308 performs a dequantization process in JPEG decoding to reverse the quantization process applied during JPEG encoding. The dequantization process starts with the sequence of quantized coefficients 306 output as a result of the decoding process performed by the processor 202 according to the decoding process logic 402. The sequence of quantized coefficients 306 have been compressed by the quantization process in the encoder, where each coefficient was divided by a corresponding value in a quantization matrix and rounded. This step significantly reduces the file size but introduces lossiness. The dequantization circuit 308 then accesses a quantization matrix (or matrices) used during the encoding process. The quantization matrix contains values used to scale down the sequence of quantized coefficients 306 during compression.

The dequantization circuit 308 then multiplies each coefficient in the sequence of quantized coefficients 306 by its corresponding value in the quantization matrix. This operation is the inverse of the quantization step performed during encoding (i.e., division). The result is the sequence of rescaled coefficients 310, which are approximations of the original DCT coefficients before quantization. By multiplying with the quantization matrix, the frequency data represented by the quantized coefficients 306 is approximately restored. However, due to the lossy nature of the quantization process, this restoration is often not perfect, and some data loss or quality degradation is possible.

Scaling in the JPEG-like codecs is typically not identical to scaling in the JPEG codec. For this reason, in one or more implementations, the decoding process performed by the processor 202 according to the decoding process logic 402 includes rescaling to generate the quantized coefficients 306, which the JPEG decoder components in the multimedia unit 124 then treat as if the quantized coefficients 306 were normal quantised coefficients directly from a JPEG image. The rescaling, in some implementations, additionally includes rescaling the quantization matrix.

As such, FIG. 5 depicts the input interface 302 providing the quantized coefficients 306 directly to the inverse transform circuit and bypassing the dequantization circuit 308. The alternative case in which some rescaling is performed is also depicted with the input interface 302 providing the quantized coefficients 306 to the dequantization circuit 308 for rescaling into the sequence of rescaled coefficients 310. The dequantization circuit 308 then multiplies each coefficient in the sequence of quantized coefficients 306 by its corresponding value in the quantization matrix. This operation is the inverse of the quantization step performed during encoding (i.e., division). The result is the sequence of rescaled coefficients 310, which are approximations of the original DCT coefficients before quantization. By multiplying with the quantization matrix, the frequency data represented by the quantized coefficients 306 is approximately restored. However, due to the lossy nature of the quantization process, this restoration is not perfect, and some data loss or quality degradation is possible.

Once dequantization is complete, the sequence of rescaled coefficients 310 is provided to the inverse transform circuit 312 (e.g., an inverse DCT). Alternatively, the sequence of quantized coefficients 306 is provided directly to the inverse transform circuit 312 which transforms the sequence of rescaled coefficients 310 or the sequence of quantized coefficients 306, as the case may be, back into pixel values, completing reconstruction of the video data 206 into the video 220. The inverse transform circuit 312 provides the video 220 to the output interface 314 that is configured to output the video 220, for example, to the display 130.

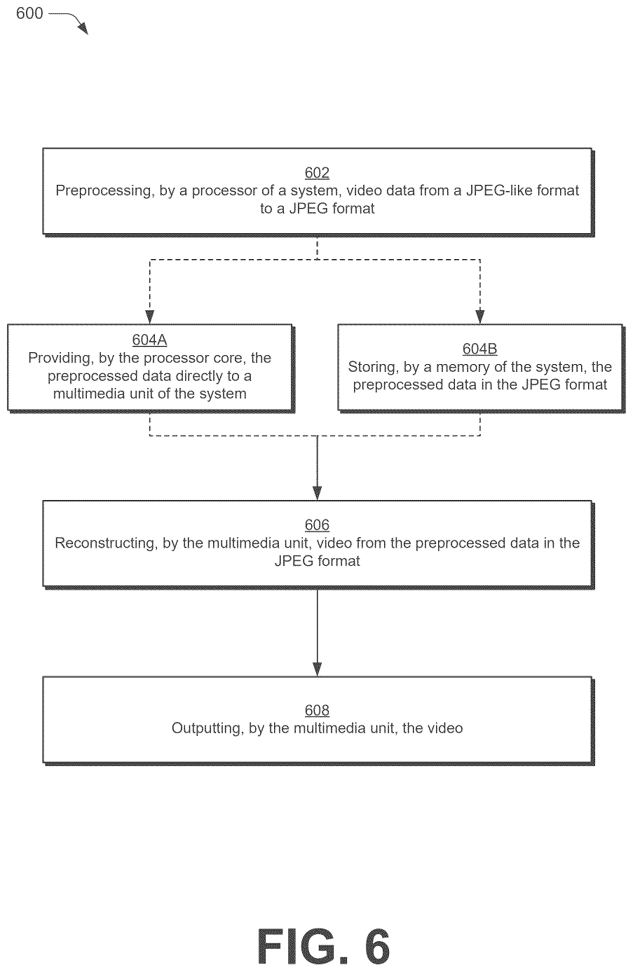

FIG. 6 depicts a method 600 for decoding JPEG-like codecs. The method 600 will be described from the perspective of a processor, a multimedia unit, and a memory of a system embodied as the processor 202, the multimedia unit 124, and the memory 106 of the system 200 described above with respect to FIG. 2.

At step 602, the processor 202 preprocesses the video data 206 in the JPEG-like format 210 to convert it to the JPEG format 216. For example, the processor 202 is configured to perform video format conversion to convert the video data 206 in the JPEG-like format 210 into the preprocessed data 134 in the JPEG format 216. In one or more implementations, the processor 202 is configured to execute instructions (e.g., of video format conversion software) to perform the video format conversion. For example, the processor 202 embodied as a CPU is configured to execute instructions of the video format conversion software to convert the video data 206 in the JPEG-like format 210 into the preprocessed data 134 in the JPEG format 216. In other implementations, the processor 202 includes hardware configured to perform the video format conversion in hardware. For example, the processor 202 includes special-purpose hardware (e.g., an FPGA or ASIC) that performs the video format conversion. Hybrid solutions for the video format conversion are also contemplated, such as using hardware acceleration techniques to improve efficiency and quality of the conversion.

At step 604A, the processor 202 provides the preprocessed data 134 in the JPEG format 216 directly to the multimedia unit 124 for further processing. Alternatively, at step 604B, the memory 106 stores the preprocessed data 134 in the JPEG format 216. For example, the memory 106 stores the preprocessed data 134 until the multimedia unit 124 is ready for further processing.

At step 606, the multimedia unit 124 reconstructs the video 220 from the preprocessed data 134 in the JPEG format 216. In particular, the multimedia unit 124 reads, via the input interface 302, the preprocessed data 134 (e.g., directly from the multimedia unit 124 or read from the memory 106), decodes, via the JPEG entropy decoder 304, the preprocessed data 134 to reconstruct the sequence of quantized coefficients 306, dequantizes, via the dequantization circuit 308, the sequence of quantized coefficients 306 into the sequence of rescaled coefficients 310, and applies an inverse transform, via the inverse transform circuit 312, to the sequence of rescaled coefficients 310 to create the video 220.

At step 608, the multimedia unit 124 outputs the video 220. For example, the multimedia unit 124 outputs the video 220 to one or more displays, such as to the display 130.

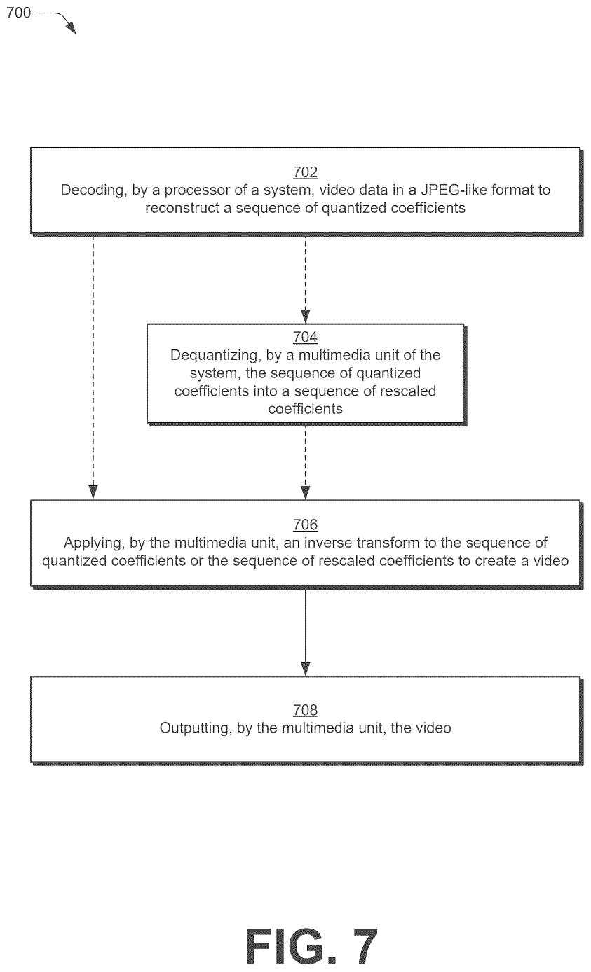

FIG. 7 depicts another method 700 for decoding data (e.g., image or video data) encoded using JPEG-like codecs. The method 700 will be described from the perspective of a processor and a multimedia unit embodied as the processor 202 and the multimedia unit 124 of the system 400 described above with respect to FIG. 5.

At step 702, the processor 202 decodes the video data 206 in the JPEG-like format 210 to reconstruct the sequence of quantized coefficients 306 as part of the decoding process performed according to the decoding process logic 402. For example, the decoding process logic 402 is executed to directly generate the sequence of quantized coefficients 306 which are given to the latter parts of the multimedia unit 124, such as to the dequantization circuit 308 and/or the inverse transform circuit 312 as described above with reference to FIG. 5.

Scaling in the JPEG-like codecs is typically not identical to scaling in the JPEG codec. For this reason, in one or more implementations, the decoding process performed by the processor 202 (e.g., at step 702) according to the decoding process logic 402 includes rescaling to generate the quantized coefficients 306, which the JPEG decoder components in the multimedia unit 124 ca treat as if the quantized coefficients 306 were normal quantised coefficients directly from JPEG-encoded data, e.g., a JPEG image or JPEG video frame. At step 704, the multimedia unit 124, and specifically the dequantization circuit 308, dequantizes the sequence of quantized coefficients 306 into the sequence of rescaled coefficients 310. For example, the dequantization circuit 308 multiplies each coefficient in the sequence of quantized coefficients 306 by its corresponding value in a quantization matrix. This operation is the inverse of the quantization step performed during encoding (i.e., division). The result is the sequence of rescaled coefficients 310, which are approximations of the original DCT coefficients before quantization. By multiplying with the quantization matrix, the frequency data represented by the sequence of quantized coefficients 306 is approximately restored. However, due to the lossy nature of the quantization process, this restoration is not perfect, and some data loss or quality degradation is possible.

At step 706, the multimedia unit 124 applies an inverse transform, via the inverse transform circuit 312 (e.g., an inverse DCT), to the sequence of quantized coefficients 306 or the sequence of rescaled coefficients 310 to create the video 220. For example, in some implementations, the processor 202 sends the sequence of quantized coefficients 306 directly to the inverse transform circuit 312 of the multimedia unit 124, thus bypassing the dequantization circuit 308. Alternatively, the dequantization circuit 308 first dequantizes the sequence of quantized coefficients 306 into the sequence of rescaled coefficients 310 at step 704 described above.

At step 708, the multimedia unit 124 outputs the video 220. For example, the multimedia unit 124 outputs the video 220 to one or more displays, such as the display 130.

It should be understood that many variations are possible based on the disclosure herein. Although features and elements are described above in particular combinations, each feature or element is usable alone without the other features and elements or in various combinations with or without other features and elements.

What is claimed is:

1. A system for decoding data encoded with a JPEG-like codec, comprising:
a processor;
a multimedia unit configured to decode encoded JPEG images; and
a memory storing instructions that, when executed by the processor, cause the processor to:
receive input data encoded with a JPEG-like codec from the memory;
preprocess the input data to produce preprocessed data compatible with JPEG decoding; and
provide the preprocessed data to the multimedia unit to decode the preprocessed data using at least a portion of a JPEG decoding process.

2. The system of claim 1, wherein the processor is a central processing unit (CPU).

3. The system of claim 1, wherein the processor is an accelerated unit (AU).

4. The system of claim 1, wherein the preprocessing includes:
converting the input data into a format compatible with JPEG decoding; and
storing the converted data in the memory.

5. The system of claim 1, wherein the multimedia unit is configured to bypass an entropy decoding step of the JPEG decoding process to decode the preprocessed data.

6. The system of claim 5, wherein the processor is further configured to perform entropy decoding specific to the JPEG-like codec.

7. The system of claim 1, further comprising a dedicated processor configured to perform the preprocessing.

8. The system of claim 7, wherein the dedicated processor is integrated with the multimedia unit and is programmable to support preprocessing for at least two JPEG-like codecs.

9. The system of claim 7, wherein the dedicated processor is a digital signal processor.

10. An apparatus for decoding data encoded with a JPEG-like codec, comprising:
a processor; and
a memory storing instructions that, when executed by the processor, cause the apparatus to:
receive input data encoded with a JPEG-like codec;
preprocess the input data to produce preprocessed data compatible with JPEG decoding; and
provide the preprocessed data to a multimedia unit configured to decode encoded JPEG images using a JPEG decoding process.

11. The apparatus of claim 10, wherein the processor is a central processing unit (CPU).

12. The apparatus of claim 10, wherein the processor is an accelerated unit (AU).

13. The apparatus of claim 10, wherein the processor is a digital signal processor (DSP) integrated with the multimedia unit.

14. The apparatus of claim 10, wherein the preprocessing includes:
converting the input data into a format compatible with JPEG decoding; and
storing the converted data in the memory.

15. The apparatus of claim 10, wherein the processor is further configured to perform entropy decoding specific to the JPEG-like codec to cause the multimedia unit to bypass an entropy decoding step of the JPEG decoding process.

16. A method for decoding JPEG-like codecs using JPEG decoding hardware, comprising:
receiving, by a processor, input data encoded in a JPEG-like codec format;
preprocessing, by the processor, the input data to produce preprocessed data compatible with JPEG decoding; and
decoding, by a multimedia unit configured for JPEG decoding, the preprocessed data using at least a portion of a JPEG decoding process.

17. The method of claim 16, wherein the preprocessing includes:
decoding entropy-coded data specific to the JPEG-like codec; and
reordering coefficient data to be compatible with JPEG decoding.

18. The method of claim 16, wherein decoding the preprocessed data comprises bypassing at the multimedia unit an entropy decoding step of the JPEG decoding process.

19. The method of claim 18, wherein the preprocessed data is input to a dequantization step of the JPEG decoding process.

20. The method of claim 19, further comprising multiplying the preprocessed data by a per-slice quantizer value specific to the JPEG-like codec prior to inputting the preprocessed data to the dequantization step.
